(19) United States
(12) Patent Application Publication
(10) Pub. No.: US 2021/0073798 A1
(43) Pub. Date: Mar. 11, 2021

(54) PRODUCT PAYMENT DEVICE AND PAYMENT METHOD UTILIZING A BLOCKCHAIN SYSTEM, AND NON-TRANSITORY STORAGE MEDIUM

(71) Applicant: HON HAI PRECISION INDUSTRY CO., LTD., New Taipei (TW)

(72) Inventor: SHIAW-HERNG LIU, New Taipei (TW)

(21) Appl. No.: 16/708,744

(22) Filed: Dec. 10, 2019

(30) Foreign Application Priority Data
Sep. 11, 2019 (CN) 201910859803.5

(51) Int. Cl. G06Q 20/36; H04L 9/06; G06Q 20/06; G06Q 30/06

(52) U.S. Cl. CPC G06Q 20/3678; H04L 9/0637; G06Q 30/0635; G06Q 20/3676; G06Q 20/3674; G06Q 20/0658

(57) ABSTRACT

A product payment method applied in a blockchain system verifies a product payment when detecting initiation of a product payment. The method broadcasts a verification passed information to the blockchain system when the verification is passed. The method further saves a name and a quantity of the one or more products purchased by the consumer for delivery from the one or more distributors when the quantity of the verification passed information received by the node is greater than a first preset value. The method also updates the name and the quantity of the one or more products of the consumer according to the getting information about getting one or more products from the distributor by the consumer. A related product payment device and a non-transitory storage medium are provided.

### FIELD

The subject matter herein generally relates to blockchain transactions, and particularly, to a product payment device and method utilizing a blockchain system, and a non-transitory storage medium.

### BACKGROUND

Blockchain is an innovative application of computer technology such as the distributed data storage, point-to-point transmission, consensus mechanism, and encryption algorithm. The blockchain employs consensus mechanism to achieve a mathematical algorithm. The mathematical algorithm establishes trust and obtains rights between different nodes in the blockchain system. In blockchain technology, a unique blockchain address is employed by a user to represent the identity and the funds of the user, and a set of public keyword and private keyword are employed to identify the user and the funds of the user.

The real identity of the user will not be exposed in the blockchain network. A product online payment platform in the prior art substantially employs a method for paying deposited cash to ensure a safe payment. However, an information of the user (identity and funds) may be leaked, thus the information of the user may be stolen, even the fund of the user may be lost. Frequent delivery to a user by an express service makes such information leak more likely to happen.

### BRIEF DESCRIPTION OF THE DRAWINGS

Implementations of the present technology will now be described, by way of embodiment, with reference to the attached figures.

FIG. 1 illustrates a block view of an embodiment of a blockchain system.

FIG. 2 illustrates a block view of an embodiment of a product payment device in the system of FIG. 1.

FIG. 3 illustrates a block view of an embodiment of a product payment procedure in the product payment device of FIG. 2.

FIG. 4 illustrates a flowchart of an embodiment of a product payment method applied to blockchain.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device.

The term “comprising” means “including, but not necessarily limited to”; it specifically indicates open-ended inclusion or membership in a so-described combination, group, series, and the like.

Embodiments of the present disclosure will be described with reference to the accompanying drawings.

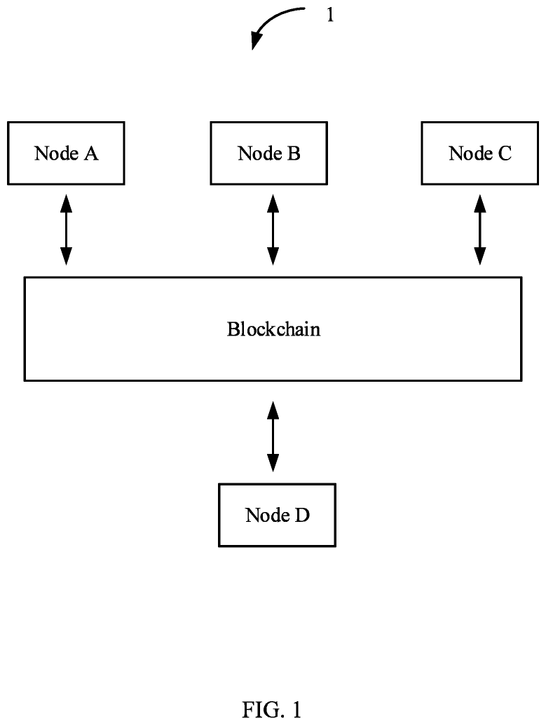

FIG. 1 illustrates a block view of an embodiment of a blockchain system. The blockchain system includes a blockchain network and a blockchain. The blockchain network includes a number of nodes. Each node records and saves account balance and a blockchain address of a consumer, or account balance and a blockchain address of a manufacturer, or account balance and a blockchain address of a distributor. Users, for example consumers, the manufacturers, and the distributors, each employs a unique blockchain address to represent the identity and the funds of the user, and employs a set of public keyword and private keyword to identify the user and the funds of the user. The consumers, the manufacturers, and the distributors each can use a client terminal, for example, a computer, a smart phone, or the like, to communicate with any node, that is, to further interact with a smart contact. Thus, the paying of the one or more products and the getting of the one or more products can be achieved. For example, the consumers, the manufacturers, and the distributors each can communicate with any node through a webpage or an application of the smart phone.

In FIG. 1, the blockchain network includes four nodes, respectively A, B, C, and D. However, the number of the nodes is not limited to four, the blockchain network can includes more modes which are not shown in FIG. 1.

In the embodiment, the manufacturers may be providing any goods or services, by street retail or online, for example product markers, or the electricity supplier platforms, or the like.

In can be understood that, each node may account the block based on the consensus mechanism. When any node broadcasts the information or the block to the blockchain network, the other nodes each can receive and verify the received block. When a ratio of a quantity of verification passed nodes to a quantity of total nodes in the blockchain network is greater than a preset threshold value, the verifying of the blockchain network to the block is determined to be passed, and all nodes can accept and account the block.

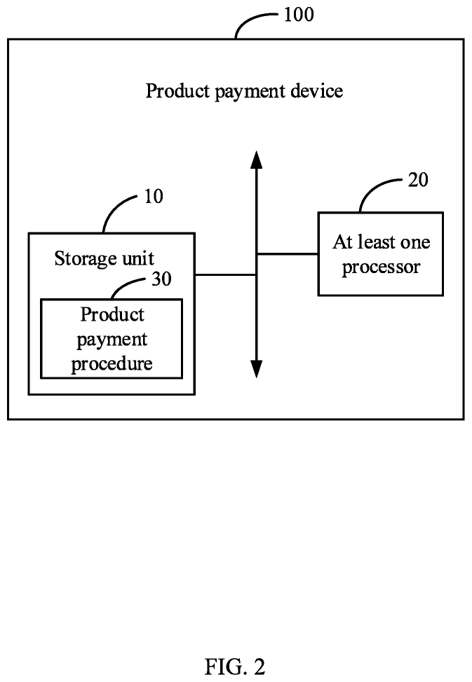

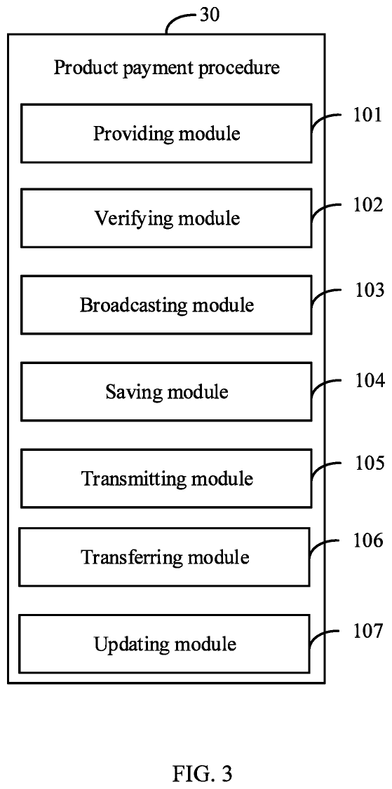

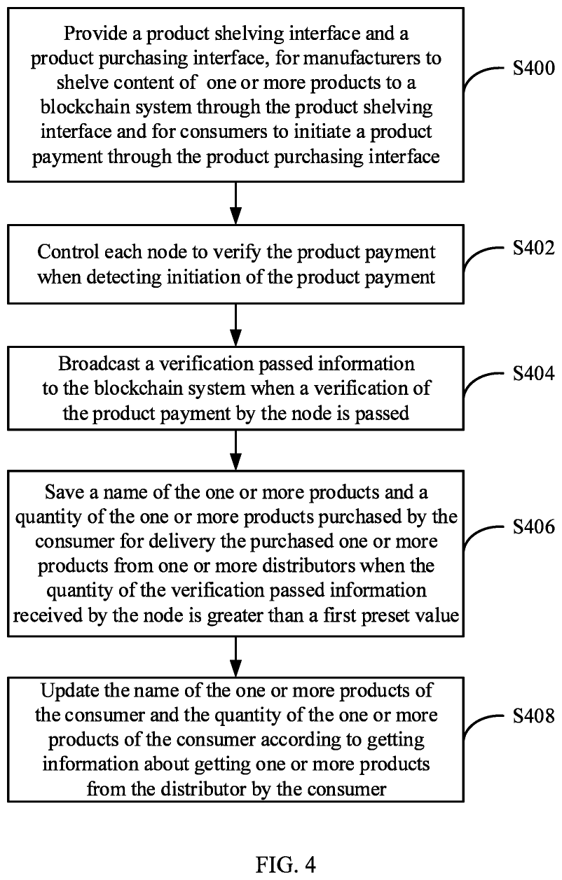

Referring also to FIG. 2, the product payment device may be a server of the blockchain payment platform. The product payment device 100 includes a storage unit 10, at least one processor 20, and a product payment procedure 30 stored in the storage unit 10 and can be run on the at least one processor 20. The at least one processor 20 can execute the product payment procedure 30 to accomplish the steps of the product payment method, for example accomplish the steps S400-S408 of FIG. 4. Or, the at least one processor 20 can execute the product payment procedure 30 to accomplish the function of the modules of the product payment procedure 30, for example accomplish the function of the modules 101-107 of FIG. 3.

The product payment procedure 30 can be divided into one or more modules/units. The one or more modules/units can be stored in the storage unit 10 and executed by the at least one processor 20 to accomplish the process and purpose of the present disclosure. The one or more modules/units can be a series of program instruction segments which can perform specific functions, and the instruction segment is configured to describe the execution process of the product payment procedure 30 in the product payment device. For example, the product payment procedure 30 can be divided into a providing module, a verifying module, a broadcasting module, a saving module, a transmitting module, a transferring module, and an updating module as shown in FIG. 3. The detail function of each module can refer to the function of the module described as follows in FIG. 3.

It can be understood that, the block view exemplified is only illustrative of the product payment device. The block view is not to be considered as limiting the product payment device. Additional components can be added, or fewer components can be utilized, or some components can be combined, or different components can be altered without departing from this disclosure. For example, the product payment device may include network accessing device, a bus, or the like.

The at least one processor 20 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 20 can be a microprocessor or the at least one processor 20 can be any regular processor, or the like. The at least one processor 20 can be a control center of the electronic device, using a variety of interfaces and lines to connect various parts of the entire electronic device.

The storage unit 10 stores the product payment procedure 30 and/or modules/units. The at least one processor 20 can run or execute the product payment procedure 30 and/or modules/units stored in the storage unit 10, call out the data stored in the storage unit 10, and accomplish the various functions of the product payment device. In addition, the storage unit 10 can include non-transitory storage medium, such as hard disk, memory, plug-in hard disk, smart media card, secure digital, flash card, at least one disk storage device, flash memory, or other transitory storage medium.

FIG. 3 illustrates a block view of an embodiment of the product payment procedure 30.

The product payment procedure 30 can include the providing module 101, the verifying module 102, the broadcasting module 103, the saving module 104, the transmitting module 105, the transferring module 106, and the updating module 107 as shown in FIG. 3.

In the embodiment, the modules can be stored in the storage unit and can be run on the at least one processor. It can be understood that, in other embodiments, the modules can be instructions or firmware solidified in the at least one processor.

The providing module 101 is configured to provide a product allocating or product reserving interface (shelving interface) and a product purchasing interface, for the manufacturers to shelve the content of the one or more products to the blockchain system through the product shelving interface and for the consumers to initiate a product payment through the product purchasing interface.

In the embodiment, in the blockchain system, any one user can employ the private keyword to transfer the funds of the user to the address of the blockchain of the other users. Each node in the blockchain system can record and save account balance and the blockchain address of the consumer, or account balance and the blockchain address of the manufacturer, or account balance and the blockchain address of the distributor. To achieve the product payment, the product payment device must provide the product shelving interface and the product purchasing interface, for the seller to shelve the one or more products and the buyer to purchase the one or more products. In detail, the providing module 101 provides the product shelving interface and the product purchasing interface, thus the manufacturers may shelve the content of the one or more products to the blockchain system through the product shelving interface, and the consumers may purchase the one or more products through the product purchasing interface, to initiate the product payment.

In the embodiment, the content of each product may include a name of the product, a price of the product, a unique identifier of the product, a quantity of the shelved product, and so on.

The verifying module 102 is configured to control each node in the nodes A-D to verify the product payment when detecting initiation of the product payment.

In the embodiment, the product payment includes the name of the one or more products and the quantity of the one or more products. For example, the consumer may access the node A through the application of the smart phone and initiate the product payment, to do the payment. The verifying module 102 is configured to control each node in the nodes A-D to verify the product payment.

In the embodiment, the verification of each node may include confirming that the product payment is indeed initiated by the consumer and the authentication of the current product payment.

The broadcasting module 103 is configured to broadcast a verification passed information to the blockchain system when the verification to the product payment by the node is passed.

In the embodiment, the broadcasting module 103 broadcasts the verification passed information to the blockchain system.

It can be understood that, the node may broadcast the verification passed information to the other nodes when the verification of any node in the blockchain network to the product payment is passed. For example, node A may broadcast the verification passed information to the other modes B-D, and can also receive the verification passed information broadcast from the other nodes B-D.

The saving module 104 is configured to save the name of the one or more products and the quantity of the one or more products purchased by the consumer for delivery from the one or more distributors when the quantity of the verification passed information received by the node is greater than a first preset value.

In the embodiment, the quantity of the verification passed information received by the node being greater than the first preset value represents that the blockchain network reaches a consensus as to the product payment. The node may account the block generated in the current product payment. The saving module 104 can save the name of the one or more products and the quantity of the one or more products purchased by the consumer, for the consumer to get delivery. For example, when the quantity of the verification passed information received by the node A is greater than the first preset value, that is, the blockchain network reaches a consensus as to the product payment, the saving module 104 saves the name of the product and the quantity of the product purchased by the consumer to the node A. The consumer preferably gets the one or more purchased products from the one or more distributors offline. The manufacturer does not directly delivery the product to the consumer.

In the embodiment, the first preset value can be set according to the consensus mechanism. For example, the first preset value can be set to be 2/3 of the total nodes.

In the embodiment, when the manufacture establishes cooperation and a relationship with the distributors and each distributor includes the address of the blockchain in the blockchain system, the consumer may get a part of purchased products or all purchased products from any one distributor.

In the embodiment, the consumer may employ the unique blockchain address to represent the identity of the consumer, for getting the part of the products or the all products from the distributor.

In the embodiment, the consumer may employ the retrieving credential to get the part of the products or the all products from the distributor. In detail, the transmitting module 105 is configured to transmit the retrieving credential of the product to the consumer, for the consumer to get the one or more purchased products from the one or more distributors when the product payment is successful. The retrieving credential may include the name and the quantity of the one or more purchased products. The retrieving credential may further include an information of the distributor where the product is held. The consumer can also employ the retrieving credential to get the part of the products or the all products from any one distributor.

The transferring module 106 is configured to transfer a first amount of virtual currency from an account of the consumer to an account of the manufacturer when the product payment is successful.

In the embodiment, the first amount is a total fee of the one or more products purchased by the consumer. In detail, the first amount can be calculated according to the price of each product set by the manufacture and the quantity of the one or more products purchased by the user.

It can be understood that, the first amount can be determined by subtracting a preferential price of the product from a product value of the price of each purchased product and the quantity of the one or more purchased products.

The updating module 107 is configured to update the name of the one or more products of the consumer and the quantity of the one or more products of the consumer according to the getting information about getting one or more products from the distributor by the consumer.

In the embodiment, the updating module 107 can update the name of the one or more products of the consumer and the quantity of the one or more products of the consumer according to the getting information when the consumer gets one or more products from the distributor.

It can be understood that, when detecting a consumer request for getting the purchased product from the distributor, the identity information of the consumer must be firstly verified. When the identity information of the consumer is verified successfully, whether the product and the quantity of the product of the consumer matches the product information currently desired by the consumer is further determined. For example, whether the one or more products desired by the consumer is within the products of the consumer, and whether the quantity of the products of the consumer is equal to or greater than the quantity of the one or more products currently desired by the consumer. When the one or more products desired to get by the consumer is within the products of the consumer and the quantity of the products of the consumer is equal to or greater than the quantity of the one or more products currently desired by the consumer, the product and the quantity of the one or more products of the consumer can be determined to match the product information currently desired by the consumer. When the product and the quantity of the one or more products of the consumer matches the product information currently desired by the consumer, the retrieving payment can be determined. After the retrieving payment is completed, the name of the one or more products of the consumer and the quantity of the one or more products of the consumer can be updated according to the retrieving payment.

In the embodiment, the manufacture presets the share fee of each product to each distributor. To the same products, the share fee of the distributors set by the manufacture can be the same or different. For example, a manufacture A1 presets the share fee of a product B1 to a distributor C1 to be 5 virtual currencies, the share fee of the product B1 to a distributor C2 to be 5.5 virtual currencies, the share fee of the product B1 to a distributor C3 to be 6 virtual currencies, and the share fee of the product B1 to a distributor C4 to be 5 virtual currencies,

In the embodiment, the transferring module 106 is further configured to transfer a second amount of the virtual currency from the account of the manufacturer to the account of the distributor when detecting that the consumer gets one or more products from the distributor. The second amount of the virtual currency is determined according to the share fee and the quantity of the products got by the consumer. For example, the manufacture A1 presets the share fee of the product B1 to the distributor C1 to be 5 virtual currencies, when the consumer purchases two products B1 from the manufacture A1 and gets two products B1 from the distributor C1, the transferring module 106 transfers ten virtual currencies from the account of the manufacturer to the account of the distributor C1.

For example, the address of the blockchain of the consumer is ABCD, the address of the blockchain of the manufacturer A1 is AAAA, the address of the blockchain of the distributor C1 is CCCC, and the address of the blockchain of the distributor C2 is DDDD, the product payment is described as follows:

a): as shown in Table 1, the manufacturer A1 shelves the product B1 and the product B2 to the blockchain system, the manufacturer A1 sets the price of the product B1 to be 20 virtual currencies, the share fee of the product B1 to the distributor C1 to be 10 virtual currencies, the share fee of the product B1 to the distributor C2 to be 12 virtual currencies, the manufacturer A1 sets the price of the product B2 to be 25 virtual currencies, the share fee of the product B2 to the distributor C1 to be 15 virtual currencies, the share fee of the product B2 to the distributor C2 to be 15 virtual currencies.

TABLE 1

| Manufacturer | Product | Price | Distributor | Share fee |
|---|---|---|---|---|
| A1 | B1 | Twenty | C1 | Ten |
| | | | C2 | Twelve |
| | B2 | Twenty-five | C1 | Fifteen |
| | | | C2 | Fifteen |

b): the consumer purchases two products B1 with forty virtual currencies.

c): the smart contact transfers forty virtual currencies from the account of the consumer to the account of the manufacturer Al.

d): the smart contact updates the quantity of the product B1 of the consumer to be two. In the embodiment, before purchasing, the quantity of the product B1 of the consumer is zero.

e): the consumer comes to the distributor C1 to get one product B1.

f): the smart contact updates the quantity of the product B1 of the consumer to be one.

g): the smart contact transfers ten virtual currencies from the account of the manufacturer A1 to the account of the distributor C1.

h): the consumer comes to the distributor C2 to get one product B1.

i): the smart contact updates the quantity of the product B1 of the consumer to be zero.

j): the smart contact transfers twelve virtual currencies from the account of the manufacturer A1 to the account of the distributor C2.

FIG. 4 illustrates a flowchart of an embodiment of a product payment method. The illustrated order of blocks is illustrative only and the order of the blocks can be changed.

At block S400, providing a product shelving interface and a product purchasing interface, fo the manufacturers to shelve the content of the one or more products to the blockchain system through the product shelving interface and for the consumers to initiate a product payment through the product purchasing interface.

At block S402, controlling each node to verify the product payment when detecting initiation of the product payment.

At block S404, broadcasting a verification passed information to the blockchain system when the verification to the product payment by the node is passed.

At block S406, saving the name of the one or more products and the quantity of the one or more products purchased by the consumer for delivery the purchased one or more products from the one or more distributors when the quantity of the verification passed information received by the node is greater than a first preset value.

At block S408, updating the name of the one or more products of the consumer and the quantity of the one or more products of the consumer according to the getting information about getting one or more products from the distributor by the consumer.

The aforementioned product payment device and method utilizing the blockchain system, and the non-transitory storage medium can avoid a leakage of the information of the user, a loss of the fund of the user at the extreme, and the consumer can gets the part of purchased products and the all purchased products from different distributors.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A product payment device utilizing a blockchain system, the blockchain system comprising a plurality of nodes, each node saving account balance and a blockchain address of a consumer, or account balance and a blockchain address of a manufacturer, or account balance and a blockchain address of a distributor, the product payment device utilizing a blockchain system comprising:
a storage system;
at least one processor; and
the storage system storing one or more programs, which when executed by the at least one processor, causing the at least one processor to:
control each node to verify a product payment when detecting initiation of the product payment;
broadcast a verification passed information to the blockchain system when the verification to the product payment by the node is passed;
save a name of the one or more products and a quantity of the one or more products purchased by the consumer for delivery from the one or more distributors when the quantity of the verification passed information received by the node is greater than a first preset value;
update the name of the one or more products of the consumer and the quantity of the one or more products of the consumer according to the getting information about getting one or more products from the distributor by the consumer.

2. The product payment device utilizing a blockchain system as described in claim 1, wherein causing the at least one processor to:
save the name of the one or more products and the quantity of the one or more products purchased by the consumer for delivery a part of the purchased products or all products from any one distributor.

3. The product payment device utilizing a blockchain system as described in claim 1, wherein causing the at least one processor to:
save the name of the one or more products and the quantity of the one or more products purchased by the consumer;
transmit a retrieving credential of the product to the consumer, for delivery the one or more purchased products from the one or more distributors.

4. The product payment device utilizing a blockchain system as described in claim 3, wherein causing the at least one processor to:
transmit the retrieving credential of the product to the consumer, for delivery the part of the purchased products or the all products from any one distributor.

5. The product payment device utilizing a blockchain system as described in claim 1, wherein further causing the at least one processor to:
transfer a first amount of virtual currency from an account of the consumer to an account of the manufacturer when the product payment is successful, the first amount being a total fee of the one or more products purchased by the consumer.

6. The product payment device utilizing a blockchain system as described in claim 1, wherein further causing the at least one processor to:
transfer a second amount of the virtual currency from an account of the manufacturer to an account of the distributor when detecting that the consumer gets one or more products from the distributor, the second amount of the virtual currency is determined according to share fee of each product preset by the manufacturer for each distributor and the quantity of the products got by the consumer.

7. The product payment device utilizing a blockchain system as described in claim 1, wherein causing the at least one processor to:
verify an identity information of the consumer when detecting a consumer request for getting the purchased product from the distributor;
determine whether the product and the quantity of the product of the consumer match the product information currently desired by the consumer when the identity information of the consumer is verified successfully;
determine to execute the retrieving payment when the product and the quantity of the one or more products of the consumer matches the product information currently desired by the consumer; and
update the name of the one or more products of the consumer and the quantity of the one or more products of the consumer according to a retrieving payment after the retrieving payment is completed.

8. A product payment method utilizing a blockchain system, applicable in a product payment device with a storage system, and at least one processor, comprising:
the at least one processor controlling each node in the blockchain system to verify a product payment when detecting initiation of the product payment;
the at least one processor broadcasting a verification passed information to the blockchain system when the verification to the product payment by the node is passed;
the at least one processor saving a name of the one or more products and a quantity of the one or more products purchased by the consumer for delivery from the one or more Page 21 of 28 distributors when the quantity of the verification passed information received by the node is greater than a first preset value;
the at least one processor updating the name of the one or more products of the consumer and the quantity of the one or more products of the consumer according to the getting information about getting one or more products from the distributor by the consumer.

9. The product payment method utilizing a blockchain system as described in claim 8, the method further comprising:
the at least one processor saving the name of the one or more products and the quantity of the one or more products purchased by the consumer for delivery a part of the purchased products or all products from any one distributor.

10. The product payment method utilizing a blockchain system as described in claim 8, the method comprising:
the at least one processor saving the name of the one or more products and the quantity of the one or more products purchased by the consumer;
the at least one processor transmitting a retrieving credential of the product to the consumer, for delivery the one or more purchased products from the one or more distributors.

11. The product payment method utilizing a blockchain system as described in claim 10, the method comprising:
the at least one processor transmitting the retrieving credential of the product to the consumer, for delivery the part of the purchased products or the all products from any one distributor.

12. The product payment method utilizing a blockchain system as described in claim 8, the method further comprising:
the at least one processor transferring a first amount of virtual currency from an account of the consumer to an account of the manufacturer when the product payment is successful, the first amount being a total fee of the one or more products purchased by the consumer.

13. The product payment method utilizing a blockchain system as described in claim 8, the method further comprising:
the at least one processor transferring a second amount of the virtual currency from an account of the manufacturer to an account of the distributor when detecting that the consumer gets one or more products from the distributor, the second amount of the virtual currency is determined according to share fee of each product preset by the manufacturer for each distributor and the quantity of the products got by the consumer.

14. The product payment method utilizing a blockchain system as described in claim 8, the method comprising:
the at least one processor verifying an identity information of the consumer when detecting a consumer request for getting the purchased product from the distributor;
the at least one processor determining whether the product and the quantity of the product of the consumer match the product information currently desired by the consumer when the identity information of the consumer is verified successfully;
the at least one processor determining to execute the retrieving payment when the product and the quantity of the one or more products of the consumer matches the product information currently desired by the consumer; and
the at least one processor updating the name of the one or more products of the consumer and the quantity of the one or more products of the consumer according to a retrieving payment after the retrieving payment is completed.

15. A non-transitory storage medium storing a set of instructions, when the instructions being executed by at least one processor of a product payment device utilizing a blockchain system, the at least one processor being configured to perform a product payment method utilizing a blockchain system, wherein the method comprises:
the at least one processor controlling each node in the blockchain system to verify a product payment when detecting initiation of the product payment;
the at least one processor broadcasting a verification passed information to the blockchain system when the verification to the product payment by the node is passed;
the at least one processor saving a name of the one or more products and a quantity of the one or more products purchased by the consumer for delivery from the one or more distributors when the quantity of the verification passed information received by the node is greater than a first preset value;
the at least one processor updating the name of the one or more products of the consumer and the quantity of the one or more products of the consumer according to the getting information about getting one or more products from the distributor by the consumer.

16. The non-transitory storage medium as described in claim 15, wherein the method comprises:
the at least one processor saving the name of the one or more products and the quantity of the one or more products purchased by the consumer for delivery a part of the purchased products or all products from any one distributor.

17. The non-transitory storage medium as described in claim 15, wherein the method comprises:
the at least one processor saving the name of the one or more products and the quantity of the one or more products purchased by the consumer;
the at least one processor transmitting a retrieving credential of the product to the consumer, for delivery the one or more purchased products from the one or more distributors.

18. The non-transitory storage medium as described in claim 15, wherein the method further comprises:
the at least one processor transferring a first amount of virtual currency from an account of the consumer to an account of the manufacturer when the product payment is successful, the first amount being a total fee of the one or more products purchased by the consumer.

19. The non-transitory storage medium as described in claim 15, wherein the method further comprises:
the at least one processor transferring a second amount of the virtual currency from an account of the manufacturer to an account of the distributor when detecting that the consumer gets one or more products from the distributor, the second amount of the virtual currency is determined according to share fee of each product preset by the manufacturer for each distributor and the quantity of the products got by the consumer.

20. The non-transitory storage medium as described in claim 15, wherein the method further comprises:
the at least one processor verifying an identity information of the consumer when detecting a consumer request for getting the purchased product from the distributor;
the at least one processor determining whether the product and the quantity of the product of the consumer match the product information currently desired by the consumer when the identity information of the consumer is verified successfully;
the at least one processor determining to execute the retrieving payment when the product and the quantity of the one or more products of the consumer matches the product information currently desired by the consumer; and
the at least one processor updating the name of the one or more products of the consumer and the quantity of the one or more products of the consumer according to a retrieving payment after the retrieving payment is completed.
